(19) United States
(12) Patent Application Publication
(10) Pub. No.: US 2008/0173422 A1
(43) Pub. Date: Jul. 24, 2008

(54) Method For Producing A Continuous Casting Mold And Corresponding Continuous Casting Mold

(76) Inventors: Gereon Fehlemann, Dusseldorf (DE); Albrecht Girgensohn, Dusseldorf (DE)

Correspondence Address: FRIEDRICH KUEFFNER, 317 MADISON AVENUE, SUITE 910, NEW YORK, NY, 10017, US

(21) Appl. No.: 11/885,808

(22) PCT Filed: Mar. 10, 2006
(86) PCT No.: PCT/EP2006/002164

§ 371 Date: Sep. 6, 2007

(30) Foreign Application Priority Data
Mar. 10, 2005 (DE) 10 2005 011 532.2
Mar. 24, 2005 (DE) 10 2005 023745.2

(51) Int. Cl. B22C 9/00; B24B 1/00; B23C 9/00

(52) U.S. Cl. 164/418; 451/28; 409/131

(57) ABSTRACT

The invention relates to a method for producing a continuous casting mold (1), during which at least one surface (2) is mechanically machined that is in contact with molten material during normal use of the mold. The aim of the invention is to achieve a uniform distribution of the heat flux over the mold. To this end, the invention provides that, as the last working step during the production of the surface (2) of the mold (1), a mechanical machining is carried out whereby producing a surface anisotropy. The invention also relates to a continuous casting mold.

The invention concerns a method for producing a continuous casting mold, in which machining is carried out on at least one surface which is in contact with molten material during the normal use of the mold. The invention also concerns a continuous casting mold.

Continuous casting molds are known which are characterized by a special surface modification, especially for the purpose of favorably affecting heat transfer from the steel into the mold wall.

EP 1 099 496 A1 proposes that mold plates be completely or partially provided with surface texture to reduce heat flow. The texture is preferably produced by sand blasting or shot peening after machining. This makes it possible to increase the roughness of the surface of the mold that is in contact with molten material during normal use of the continuous casting mold.

JP 10 193 042 A describes a continuous casting mold in which longitudinal grooves are systematically formed in the surface of the broad-side plates. This is intended to reduce the heat flux density in the liquid metal level in order to avoid longitudinal cracks.

JP 02 020 645 A discloses a continuous casting mold in which longitudinal grooves and transverse grooves are formed in the broad-side plates in a predetermined grid pattern. The goal here is also to reduce the heat flux density in the liquid metal level and thus to reduce the risk of longitudinal cracks.

The grooves that are formed are in the range of 0.5 to 1.0 mm; the grid spacing is about 5-10 mm.

AT 269 392 discloses a continuous casting mold in which the goal is likewise to reduce the heat flux density, especially in the upper part of the mold. This is achieved by a greater wall thickness in the upper part of the mold or by the use of more strongly insulating material in this area. In this regard, the upper area of the mold either can consist entirely of this material or can be coated with this material on the water side.

FR 2 658 440 describes a continuous casting mold in which local reduction of the heat flux density is realized by forming grooves in the hot side of the mold and filling these grooves with a second material of lower thermal conductivity. In addition, the entire surface of the mold is coated with this second material.

JP 06 134 553 A and JP 03 128 149 A describe roughening the surface of casting rolls, which is intended in this application to reduce the heat flux density.

The previously known measures are intended to bring about improved thermodynamic behavior of the mold and especially its walls and improved suitability for use in continuous casting. In general, one strives for good adhesion of the casting flux to the mold plate and uniform distribution of the heat flow over the entire mold.

The thickness and the structure of the casting flux layer between the mold wall and the strand shell are critical determinants of the magnitude of the heat flux density between the steel and the mold and thus of the thermal load on both the strand shell and the mold material. Therefore, strong stresses can arise in the strand shell due to local changes and changes over time in the casting flux layer, and these stresses can cause longitudinal cracks, especially in steel grades that are susceptible to cracking. However, the surface of the mold is also subject to strong mechanical stresses due to alternating thermal loading. Therefore, the maximum heat flow in the area of the liquid metal level should be low and as uniform as possible in order to reduce the risk of cracking, especially in steel grades that are susceptible to longitudinal cracking.

An additional goal is to keep the friction between the broad sides and the narrow sides of the mold as low as possible during adjustment of the narrow sides. Finally, it is desirable to reduce the thermal stress in the liquid metal level by means of a low heat flux density for the purpose of increasing the service life of the mold.

The measures that have previously been proposed achieve these goals only partially or at relatively high production expense.

Therefore, the goal of the invention is to develop a continuous casting mold and a method for producing it, with which the aforementioned desired characteristics can be achieved as effectively as possible, with the least possible production expense, and thus at low cost.

In accordance with the invention, the solution to this problem with respect to a method is characterized by the fact that machining that produces an anisotropically textured surface is carried out as the last processing step or as one of the last processing steps in the production of the surface of the mold.

This is preferably accomplished by employing a milling process or a grinding process as the last processing step.

Anisotropy is understood to mean that the surface characteristics vary with the surface direction in which they are determined. In connection with the mold surface in question here, this means especially that various parameters, such as roughness, have different values when measured in the casting direction from their values perpendicular to the casting direction, i.e., in the direction transverse to the casting direction.

In accordance with the invention, the continuous casting mold, which has at least one machined surface that has contact with molten material during its normal use, is characterized by the fact that at least part of the surface has an anisotropic structure.

In one embodiment of the invention, the surface of the mold has greater roughness in the casting direction than in the direction transverse to the casting direction, in each case as viewed in the plane of the surface.

The anisotropically textured surface can have elevations and depressions formed and oriented in rows that run in the direction transverse to the casting direction. The elevations and depressions can be formed as corrugations, whose peaks and valleys run in the direction transverse to the casting direction; in this connection, the corrugations preferably have an essentially rounded shape in cross section. It has been found to be effective if the height of the corrugations is 2 μm to 250 μm, and especially 10 μm to 50 μm.

The height of the corrugations on the surface can remain constant or can be varied in the casting direction and/or in the direction transverse to the casting direction.

The proposal of the invention is thus aimed at producing the desired anisotropic surface structure in the last step of the machining operation to shape the surface of the mold. In this regard, the machined surface can be shaped in such a way that the macroscopic structure produced in the casting direction is different from that produced transverse to the casting direction. The microscopic roughness of the surface can also be formed differently in the casting direction and the direction transverse to the casting direction.

Greater roughness in the casting direction and a macroscopic structure of the surface with elevations running in rows transverse to the casting direction result in better adhesion of the casting flux layer to the mold plate near the liquid metal level, so that it is not so easily rubbed off—completely or only locally—by the strand. At the same time, both the increased roughness and the macroscopic structure of the surface cause the heat flow to be reduced and evened out, which also results in a reduction of the tendency towards longitudinal cracking. In addition, the reduction of the heat flux density in the liquid metal level reduces the thermal stresses in the mold plate, which increases the service life of the mold plates.

Furthermore, it is advantageous that the desired surface texture is produced during the machining of the mold surface. This means that further processing steps, e.g., forming grooves in the surface, coating the surface in the area of the liquid metal level, or roughening the surface by sand blasting or shot peening, are not necessary, which makes the proposal of the invention economical. The advantageous anisotropic surface texture can thus be produced without great expense not only during the production of the molds but also during each reworking of the mold surface, which is necessary at certain intervals of time.

In addition, the shaping of the mold surfaces in the manner described with macroscopic elevations oriented transversely to the casting direction, or the roughness that is greater in the casting direction than in the direction transverse to the casting direction, also reduces the friction between the broad sides and the narrow sides during adjustment of the narrow sides in the case of molds that consist of individual mold plates (e.g., slab, thin slab).

A specific embodiment of the invention is illustrated in the drawings.

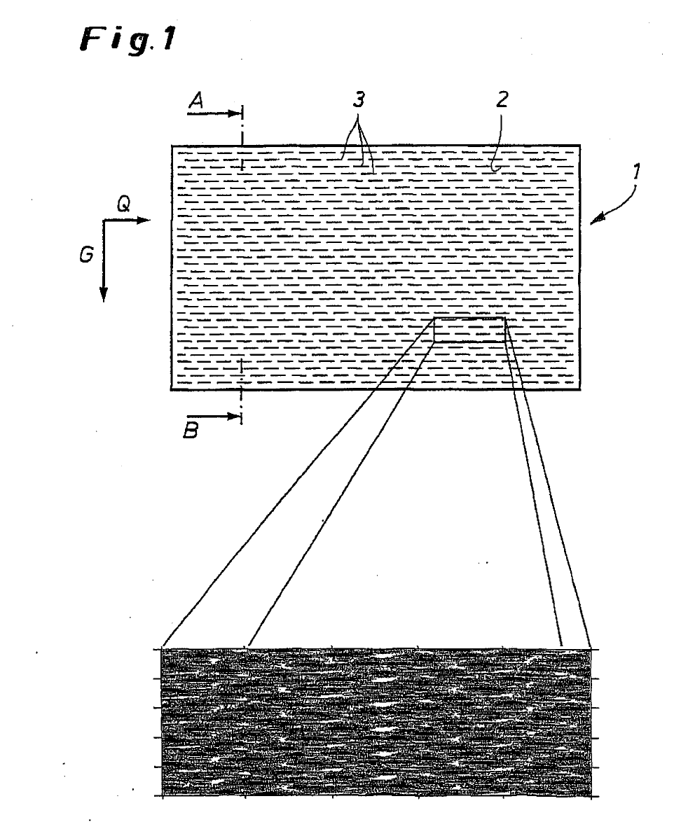

FIG. 1 shows a schematic representation of a mold plate with an anisotropic surface and an enlarged view of the surface topology.

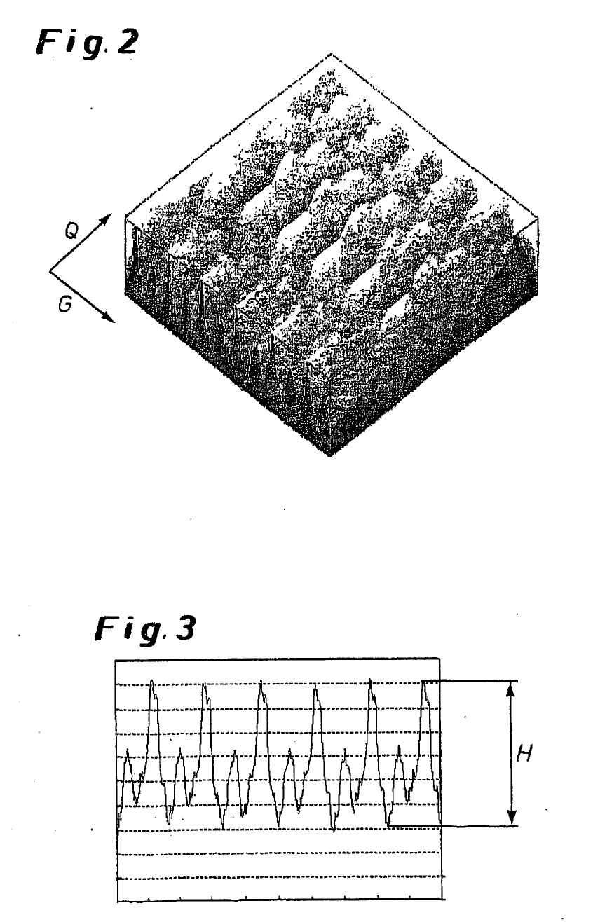

FIG. 2 shows a schematic three-dimensional view of the profile of the surface of the mold plate.

FIG. 3 shows an enlarged view of section A-B in FIG. 1.

FIG. 1 shows a view of that surface of a mold plate of a continuous casting mold 1 which is in contact with molten material (steel) or the solidified strand shell during the use of the continuous casting mold 1. The strand shell passes the mold plate in casting direction G. To achieve the advantages explained above, the surface 2 is provided with a special texture: The surface topology, especially the roughness, of the surface 2 is anisotropically formed, i.e., different roughness values are measured in casting direction G and in direction Q transverse to the casting direction G.

In this connection, the mold plate is provided with large numbers of elevations and depressions, which are shown in FIG. 1 in a highly schematic way. These elevations and depressions are produced during the last machining operation in the production of the mold plate. In the last machining step, the surface of the mold plate is milled by traverse milling, for example, with the use of a milling cutter with a diameter of 100-150 mm, which is provided with standard indexable cutter inserts, e.g., made of cemented carbide alloy. The material removal during the last machining step is less than 1 mm, and preferably less than 0.5 mm. Impressions and the structure of the elevations and depressions on the surface of the mold can be systematically adjusted according to the selected material removal and other milling parameters, such as speed of rotation, feed rate, peripheral speed, spacing of the milled rows, coolant, milling direction, and angle of attack of the tool relative to the surface of the plate (set angle).

Alternatively, the desired surface texture can be produced by a grinding process. As in the case of milling, the surface can be ground in rows. In this regard, the shape of the wavelike elevations and depressions can be produced by the surface contour of the grinding disk or by the angle of attack of the grinding disk relative to the surface of the plate.

FIG. 2 shows a three-dimensional view of the profile of the surface after the final machining. Here it is apparent that the roughness of the surface is greater in the casting direction G than in the direction Q transverse to the casting direction G. The mold plate is thus provided with a large number of elevations and depressions, which are shown only in a highly schematic way in FIG. 1. These elevations and depressions are produced during the last machining operation in the production of the mold plate.

The height H of the elevations and depressions, which are oriented in rows, is seen in FIG. 3 and is typically in the range of 2 μm to 250 μm, which can be controlled by the choice of milling parameters.

### LIST OF REFERENCE SYMBOLS

1 continuous casting mold
2 surface
3 corrugated structure
G casting direction
Q direction transverse to the casting direction
H height of the corrugations

1. A method for producing a continuous casting mold (1), in which machining is carried out on at least one surface (2) which is in contact with molten material during the normal use of the mold, wherein machining that produces an anisotropically textured surface is carried out in the last processing step or the last processing steps in the production of the surface (2) of the mold (1) in such a way that the roughness of the surface (2) of the mold (1) has different values when measured in the casting direction (G) from its values when measured in the direction (Q) transverse to the casting direction (G).

2. A method in accordance with claim 1, wherein the last processing step is a milling process.

3. A method in accordance with claim 1, wherein the last processing step is a grinding process.

4. A continuous casting mold (1), which has at least one machined surface that has contact with molten material during its normal use, especially one which is produced by the method in accordance with claim 1, wherein at least part of the surface (2) has an anisotropic structure, such that the roughness of the surface (2) of the mold (1) has different values when measured in the casting direction (G) from its values when measured in the direction (Q) transverse to the casting direction (G).

5. A continuous casting mold in accordance with claim 4, wherein the surface (2) has greater roughness in the casting direction (G) than in the direction (Q) transverse to the casting direction (G).

6. A continuous casting mold in accordance with claim 4, wherein the surface (2) has elevations and depressions formed and oriented in rows that run in the direction (Q) transverse to the casting direction (G).

7. A continuous casting mold in accordance with claim 6, wherein the elevations and depressions are formed as corrugations, whose peaks and valleys run in the direction (Q) transverse to the casting direction (G).

8. A continuous casting mold in accordance with claim 7, wherein the corrugations preferably have an essentially rounded shape in cross section.

9. A continuous casting mold in accordance with claim 7, wherein the height (H) of the corrugations is 2 μm to 250 μm, and especially 10 μm to 50 μm.

10. A continuous casting mold in accordance with claim 7, wherein the height (H) of the corrugations in the casting direction (G) is constant.

11. A continuous casting mold in accordance with claim 7, wherein the height (H) of the corrugations in the casting direction (G) is variable.
